(19) United States
(12) Patent Application Publication
(10) Pub. No.: US 2017/0095872 A1
(43) Pub. Date: Apr. 6, 2017

(54) INTEGRATED CIRCUIT ALIGNMENT TOOL

(71) Applicant: Texas Instruments Incorporated, Dallas, TX (US)

(72) Inventors: Ray D. Harrison, Garland, TX (US); Somsack Vang, Wylie, TX (US)

(21) Appl. No.: 14/872,225

(22) Filed: Oct. 1, 2015

(51) Int. Cl. B23K 3/08; B23K 1/00

(52) U.S. Cl. CPC B23K 3/08; B23K 1/0016; B23K 3/085

(57) ABSTRACT

A solderability alignment tool for aligning conductive interface surfaces of an IC with predetermined interface surfaces on a test board. The solderability tool includes a platen having a support surface for supporting a test board and an IC displacement assembly including an elongate tubular member in selective fluid communication with a vacuum source for precisely locating an IC on said test board. The tool may also include a microscope positioned opposite the platen support surface for precisely observing the position and alignment of the IC on said test board.

### BACKGROUND

One reliability test performed on integrated circuits (“IC”s) with contact surfaces, such as IC dies and IC packages, is known as a solderability alignment test. This test determines whether the IC electrical contact surfaces have proper spacing and alignment for physical attachment to a host mounting surface, such as a printed circuit (“PC”) board. Prior art alignment testing is performed by holding an IC by hand or with a grasping tool and then hand aligning and seating the IC in a desired location. As package contact or lead counts have increased and pin-to-pin spacing has decreased, it has become progressively more difficult to perform this task.

### SUMMARY

A solderability alignment tool for aligning conductive interface surfaces of an IC with predetermined interface surfaces on a test board includes a platen having a support surface for supporting a test board. The tool also has an IC displacement assembly with an elongate tubular member in selective fluid communication with a vacuum source. This displacement assembly is used to precisely locate an IC on the test board. The tool includes a microscope positioned opposite the platen support surface that enables precise observation of the position and alignment of the IC on the test board.

A tool including a platen having a support surface for supporting a substrate and an IC displacement assembly includes an elongate conduit for precisely locating an IC on the substrate. The tool also includes a microscope positioned opposite the platen support surface for precisely observing the position and alignment of the IC with the substrate. In some embodiments the tool includes a source of pressurized fluid that may be dispensed by the elongate conduit on the IC.

A tool including a platen having a support surface thereon; a pressurized fluid source; and a conduit operably connected to the pressurized fluid source for dispensing fluid on an IC supported by the platen support surface.

A method of aligning leads on an integrated circuit (IC) device with predetermined interface surfaces on a substrate includes: positioning the substrate on a platen; vacuum engaging the IC with the tip of a conduit; and displacing the engaged IC to a position opposite the substrate; and precisely positioning contact surfaces on the IC with respect to predetermined interface surfaces on the substrate while observing the IC with a microscope.

A method of making a solderability alignment tool for aligning conductive interface surfaces of an integrated circuit (IC) with predetermined interface surfaces of a substrate includes providing an electronic manual probe station having a platen, a microscope, an electrical probe and a probe displacement assembly attached to the electrical probe; and replacing the electrical probe assembly with an elongate conduit that is operably connected to the probe displacement assembly.

A method of attaching leads on an IC with predetermined interface surfaces on a substrate includes: positioning the substrate on a platen; vacuum engaging the IC with the tip of a conduit; displacing the engaged IC to a position opposite the substrate and precisely positioning contact surfaces on the IC with respect to predetermined interface surfaces on the substrate; and dispensing fluid from the tip of the conduit onto at least the IC.

### BRIEF DESCRIPTION OF THE DRAWINGS

FIG. 1 is a schematic side elevation view of an example embodiment of an IC manipulation tool.

FIG. 2 is a schematic top plan view of the IC manipulation tool of FIG. 1.

FIG. 3 is an isometric view of an example embodiment of an IC manipulation tool, which may be a solderability alignment tool.

FIG. 4 is a flowchart of a method of aligning leads on an IC with conductive interface surfaces on a substrate.

FIG. 5 is a flowchart of a method of making a solderability alignment tool.

FIG. 6 is a flowchart of a method of attaching leads on an IC with predetermined interface surfaces on a substrate.

### DETAILED DESCRIPTION

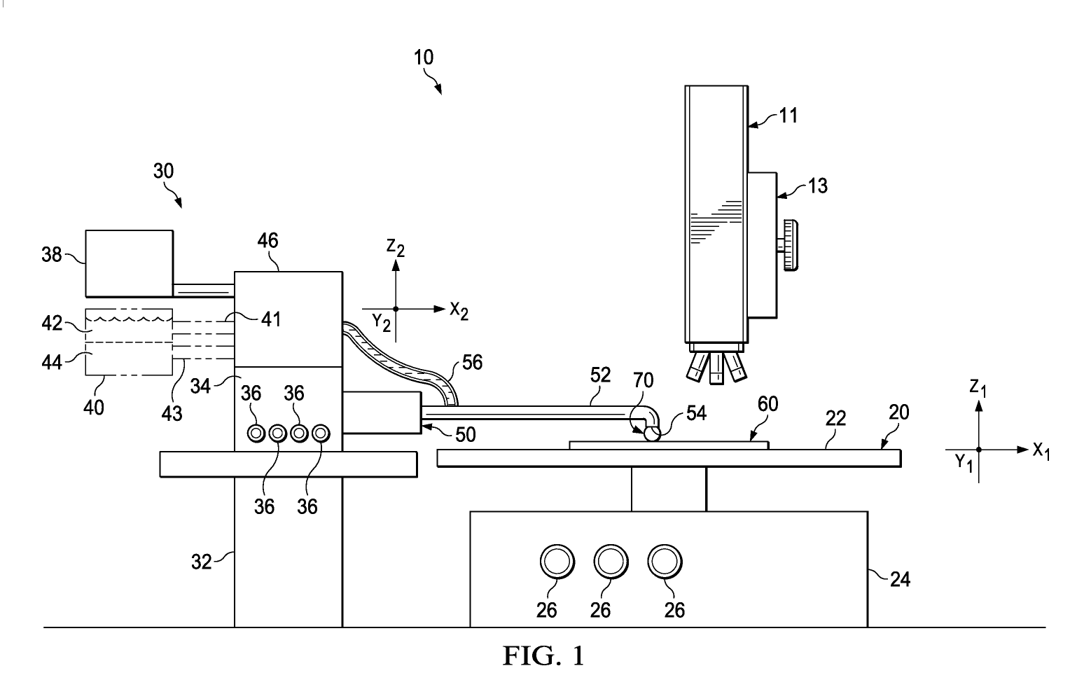

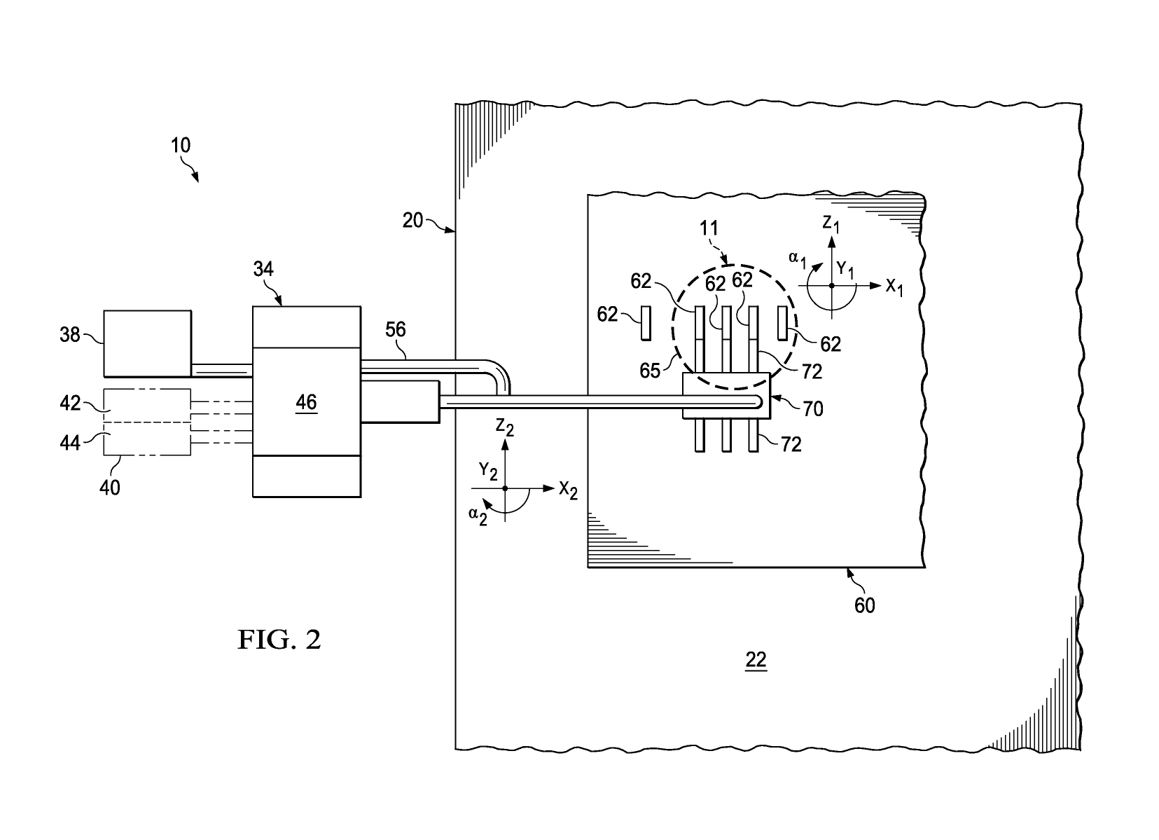

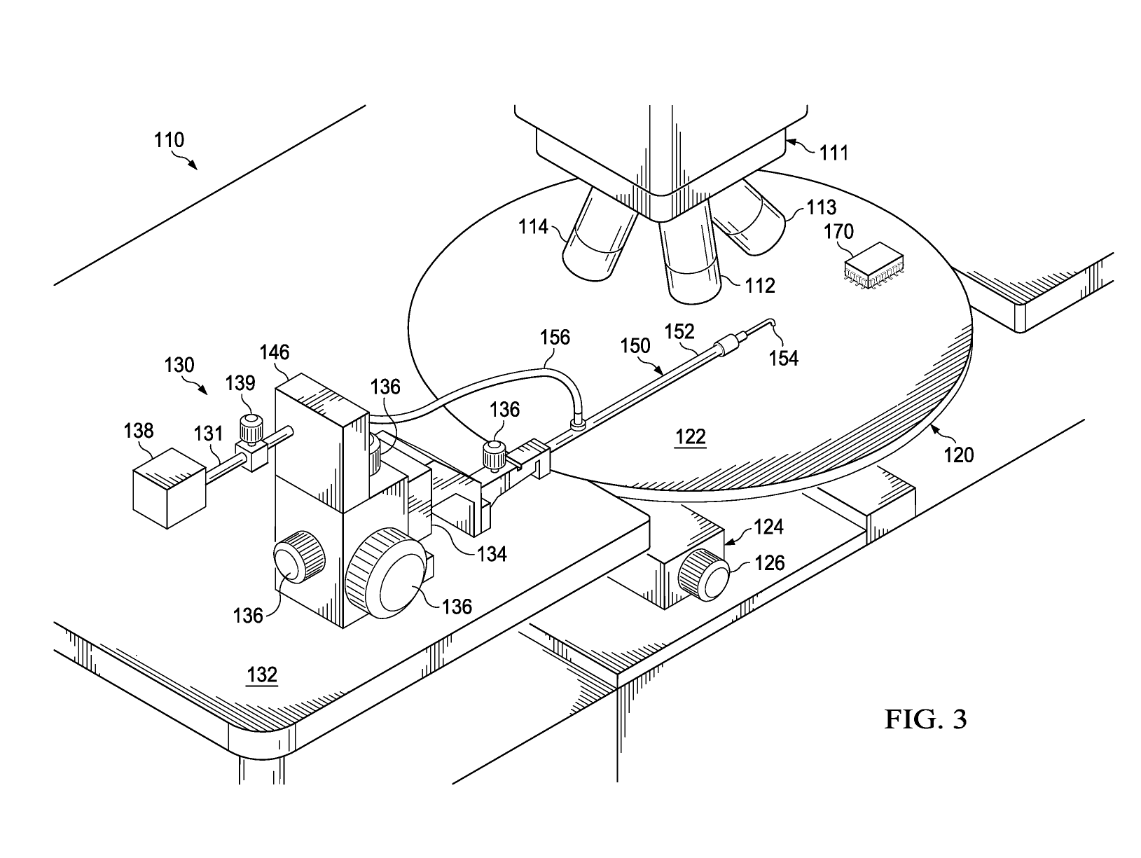

FIG. 1 is a schematic side elevation view of an example embodiment of an IC manipulation tool 10, and FIG. 2 is a top plan view thereof. In one embodiment this tool is a solderability alignment tool and this embodiment will be initially described. FIG. 3 is an isometric view of one detailed embodiment 110 of such a solderability alignment tool, which will be described after the initial description of FIGS. 1 and 2.

The IC manipulation tool 10 shown in FIGS. 1 and 2 may, with suitable modifications, be used to perform functions other than alignment of an IC including dispensing of pressurized fluid onto an IC. This modified version of the tool 10 is shown and described with added reference to the dashed lines in FIGS. 1 and 2. The description of this modified version of the tool 10 is presented after the description of the solderability alignment version of the tool 10.

The solderability alignment version of the tool 10, shown entirely in solid lines in FIGS. 1 and 2, includes a microscope 11 with a vertical displacement assembly 13, a platen 20 having a top surface 22, and a platen displacement assembly 24 with mechanical control surfaces such as knobs 26. The solderability alignment tool 10 also includes an IC displacement assembly 30 having a support stand 32 and a mechanical, displacement unit 34 with hand operated mechanical control surfaces such as rotatable knobs 36. In one embodiment, each control assembly is adapted to controllably displace the associated object in increments of less than about 1 micrometer.

A vacuum source, shown schematically at block 38, is connected to a fluid manifold 46. A displaceable arm assembly 50 includes a rigid tubular member 52 having an open distal end 54 that is adapted to engage an IC 70. The displaceable arm assembly 50 may also include a flexible conduit 56 that is in fluid communication with the fluid manifold 46 and the rigid tubular member 52.

As best illustrated by FIG. 2, a test board 60 is supported on the top surface 22 of the platen 20 and has a plurality of conductive interface surfaces 62 thereon. A IC 70, such as an IC package, has a plurality of conductive interface surfaces 72, for example, leadframe leads or balls of a ball grid array. The conductive interface surfaces 72 of the IC 70 are adapted to be aligned with the plurality of conductive interface surfaces 62 on the test board 60.

The platen displacement assembly 24, FIGS. 1 and 2, through hand actuation of control surfaces 26, initially displaces the platen 20 such that a portion of the test board 60 that is to be attached to the IC package 70 is positioned directly below the microscope 11. The platinum 20, in one embodiment, may be vertically displaced with respect to the microscope 11 to assist in focusing the microscope on the IC 70 and involved portion of the test board 60. Alternatively the microscope itself may be vertically displaced to achieve proper focus. The field of view of the microscope 11 is shown in dashed lines at 65 in FIG. 2.

The IC displacement assembly 30, in one embodiment, is hand-actuated, as by rotating the control knobs 36, to place the open tip end 54 of the tubular member 52 in contact with the IC 70. Vacuum from the vacuum source, shown schematically at block 38, is then placed in communication with the fluid manifold 46, which is also in fluid communication with the tubular member 52 through the flexible conduit 56. The vacuum causes the IC 70 to remain in contact with the tip end 54 of the displacement arm 50 as it is moved to place the IC 70 on the test board 60. The IC 70 is ultimately moved by the IC displacement assembly 50 to a position and orientation on the test board 60 where a plurality of interface surfaces 72 of the IC 70, FIG. 2, are in alignment with predetermined interface surfaces 62 of the test board 60. If the conductive interface surfaces 62 and 72 cannot be properly aligned by linear and angular displacement of the IC 70, then the IC is considered defective. In the illustration of FIG. 2, only one set of interface surfaces 62 of the test board 60 is shown, but it is to be understood that further interface surfaces 62 may be provided to align with the remainder of contacts 72, or the IC 70 may be manipulated to place contact surfaces 72 of first one side and then the other side of the IC 70 in alignment with test board interface surfaces 62.

Movement of the displacement arm assembly 50 is achieved through manipulation of the knobs 36 or other control surfaces of the IC displacement assembly 30. The position and angular orientation of the IC 70 is visually monitored by an operator using the microscope 11. Once the IC 70 is in a desired aligned position with the test board 60, the IC 70 is released from the tip end 54 of the tubular member 52 by termination of the vacuum to the tubular member. A suitable control valve (not shown) associated with the fluid manifold 46 or the vacuum source 38 may be used to initiate and terminate the vacuum to the tubular member 52. (In another embodiment the manifold 46 is eliminated and the vacuum source 38 is directly connected to the flexible conduit 56.

In the example embodiment of FIGS. 1 and 2, the platen displacement assembly 22 may be linearly displaceable along three orthogonal axes X₁, Y₁ and Z₁ and may be angularly displaceable about axis Z₁. Similarly, the IC displacement assembly 30 may be linearly displaceable along three axes X₂, Y₂ and Z₂ and may be angularly displaceable about axis Z₂. It will be understood by those skilled in the art that the relative movement needed to place an IC 70 on a test board 60 may be achieved solely by displacement of the IC 70 with the IC displacement assembly 30 or by a combination of IC displacement with the IC displacement assembly 30 and displacement of the test board 60 with the platen displacement assembly 24. Manual adjustment is performed through use of knobs 26 and 36. Alternatively the manually adjustable assemblies may be partially or entirely replaced with linear and angular actuators using stepper motors or the like and appropriate electronic controllers. The IC manipulation tool 10 as described above is operable as a solderability alignment tool.

A version of the tool 10 of FIGS. 1 and 2 may also be used for dispensing pressurized fluid onto an IC 70. In this version of the tool 10 the following structure is added: a pressurized fluid source 40, conduits 41, 43 and control valves (not shown) connecting the fluid source 40 to the fluid manifold 46, The pressurized fluid source 40 may include a heated fluid chamber 42 and a cooled fluid chamber 44. In one example embodiment the pressurized fluid is a liquid and in another embodiment it is a gas.

In this second version of the tool 10, IC 70 manipulation may be performed, if needed, in the same manner as described above. In addition, pressurized fluid may be dispensed onto the IC 70. For example, in one embodiment, the tool 10 is used for failure analysis testing.

In this embodiment an IC 70 to be failure analysis tested, has its leads 72 aligned with leads, e.g. 62, of test equipment associated with the substrate 60. The leads 62 of the test equipment may, for example, be coated with solder paste. That solder paste (not shown) is reflowed by heat provided by a heat source, such as a heating coil (not shown) positioned within the platen 22. It is known in the art that a solder bond may be improved if solder reflow takes place in an oxygen-starved environment. Such an environment may be provided by dispensing oxygen replacement gas, such as nitrogen, on the IC 70 during solder bonding. In this embodiment fluid chamber 44 is filled with pressurized nitrogen gas, which expands and cools as it is dispensed. The reflowed solder bonds leads 62 to leads 72 so that desired testing may be performed. One of the tests to be performed deals with the effect of reduced temperature on the IC 70. To reduce the temperature of the device 70, the cooled nitrogen gas is continuously dispensed for a predetermined period needed to reduce the temperature of the IC 70 to the desired test temperature. Once the desired temperature is reached, the test is performed. In a variation of this embodiment, the tubular member 52 is a double conduit. One of the two conduits dispenses the gas. The other conduit is attached to another pressurized reservoir (not shown) that is filled with solder paste. The solder paste may be dispensed through this second conduit prior to heating of the IC 70.

FIG. 3 is an isometric view of an embodiment of a solderability alignment tool 110, which is similar to the IC manipulation tool 10. The tool 110 includes a microscope 111 that may have a plurality of heads 112, 113, 114, providing different magnifications. The alignment tool 110 also includes a platen 120 having a top surface 122, and a platen displacement assembly 124 with mechanical control surfaces such as knobs 126. The solderability alignment tool 110 further includes an IC displacement assembly 130 having a support stand 132 and a mechanical, displacement unit 134 with hand operated mechanical control surfaces such as rotatable knobs 136.

A displaceable arm assembly 150 includes a rigid tubular member 152 having an open distal end tip 154 that is adapted to engage an IC (not shown in FIG. 3). The displaceable arm assembly 150 may also include a flexible conduit 156 that is in fluid communication with the rigid tubular member 152 at one end thereof and in fluid communication with an air manifold 146 at the other end thereof. A vacuum source, shown schematically by block 138, is operably connected to the manifold 146, such as through a manual control valve 139, or through a conventional electronic control valve assembly (not shown). The manifold 146 is in fluid communication with the tubular member 152 through the flexible conduit 156.

In operation, a test board (not shown in FIG. 3) is placed on the platen surface 122 below the microscope 111 and a platen displacement assembly 124 is used by an operator to move the test board such that the desired portion of the test board to which the IC is to be mounted is positioned within the microscope field of view. Next a vacuum from vacuum source 130 is applied to the rigid tubular member 152 through conduit 156, etc. Then the displaceable arm assembly 150 is moved by manipulation of knobs 136 of the IC displacement assembly 130. The displaceable arm assembly 150 is moved to a position such that its distal end tip 154 vacuum engages an IC 170 on the platen 120. The displaceable arm assembly 150 and the IC 170 are then moved to place the IC at a desired location and orientation on the test board through manipulation of control knobs 136. During the placement of the IC 170 on the test board, the operator monitors the relative position of the IC with respect to the test board with the microscope 111. Once the IC 170 is in the desired position and orientation on the test board, the operator terminates the vacuum supplied to the rigid tubular member 152, as by closing control valve 139, to release the IC 170.

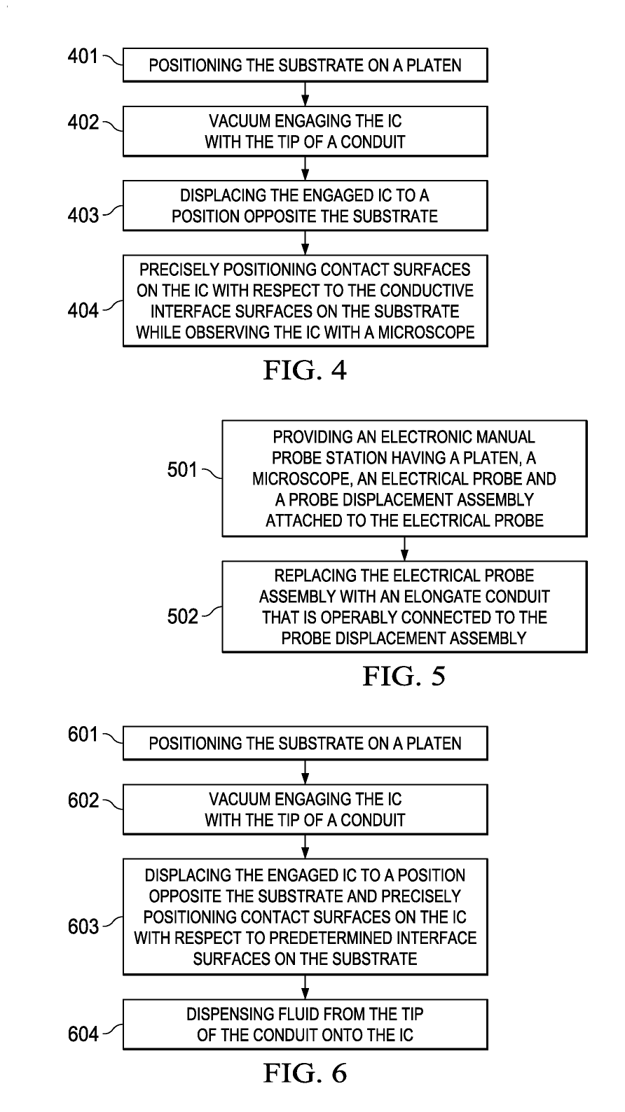

It will be appreciated from the above disclosure that, as shown in FIG. 4, a method of aligning leads on an integrated circuit (IC) with conductive interface surfaces on a substrate includes positioning the test board on a platen, as indicated at block 401. The method also includes vacuum engaging the IC with the tip of a conduit, as shown at block 402. The method further includes displacing the engaged IC to a position opposite the substrate, as indicated at block 403. The method also includes, precisely positioning leads on the IC with respect to the conductive interface surfaces on the substrate while observing the IC with a microscope, block 404.

Electronic manual probe stations with an electric probe that is mounted on and displaceable by a probe displacement assembly are known in the art. Such stations usually include a microscope and a displaceable platen positioned below the microscope. As shown in FIG. 5, a method of making a solderability alignment tool for aligning conductive interface surfaces of an IC with conductive interface surfaces of a test board includes providing an electronic manual probe station having a platen, a microscope, an electrical probe and a probe displacement assembly attached to the electrical probe, block 501. The method also includes replacing the electrical probe assembly with an elongate conduit that is operably connected to the probe displacement assembly, block 502.

FIG. 6 illustrates a method of attaching leads on an IC with predetermined interface surfaces on a substrate. The method includes positioning the substrate on a platen, as shown at block 601. The method also includes, as shown at block 602, vacuum engaging the IC with the tip of a conduit. The method further includes displacing the engaged IC to a position opposite the substrate and precisely positioning contact surfaces on the IC with respect to predetermined interface surfaces on the substrate, block 603. The method also includes, as shown at block 604, dispensing fluid from the tip of the conduit onto the IC.

Example embodiments of a solderability alignment tool and a method of making such a tool and a method of aligning leads on an integrated circuit (IC) IC with conductive interface surfaces on a test board and other associated methods have been expressly described in detail herein. Various alternative embodiments of a solderability alignment tool and associated methods will occur to those skilled in the art after reading this disclosure. It is intended that the appended claims be broadly construed to cover such alternative embodiments, except as limited by the prior art.

What is claimed is:

1. A solderability alignment tool for aligning conductive interface surfaces of an IC with predetermined interface surfaces on a test board comprising:
a platen having a support surface for supporting a test board;
a IC displacement assembly including an elongate tubular member in selective fluid communication with a vacuum source for precisely locating an IC on said test board; and
a microscope positioned opposite said platen support surface for precisely observing the position and alignment of said IC on said test board.

2. The solderability alignment tool of claim 1 further comprising a platen/microscope displacement tool for relatively displacing said platen with respect to said microscope.

3. The solderability alignment tool of claim 2 wherein said elongate tubular member is controllably displaceable in increments of less than about 1 micrometer.

4. The solderability alignment tool of claim 1, said IC displacement assembly comprising manually operable knobs for controlling displacement of said elongate tubular member about a plurality of displacement axes.

5. The solderability alignment tool of claim 2 said displacement tool comprising manually operable knobs for controlling displacement of said microscope relative said platen.

6. A tool comprising:
a platen having a support surface for supporting a substrate;
an IC displacement assembly including an elongate conduit for precisely locating an IC on said substrate; and
a microscope positioned opposite said platen support surface for precisely observing the position and alignment of said IC with said substrate.

7. The tool of claim 6 wherein said elongate conduit is in selective fluid communication with a pressurized fluid source.

8. The tool of claim 7 wherein said pressurized fluid source comprises a source of at least one of relatively heated fluid and relatively cooled fluid.

9. The tool of claim 7 wherein said pressurized fluid source comprises a pressurized liquid source.

10. The tool of claim 7 wherein said pressurized fluid source comprises a pressurized gas source.

11. The tool of claim 7 wherein said pressurized gas source is a pressurized oxygen replacement gas source.

12. The tool of claim 11 further comprising a soldering device for soldering contact surfaces on said IC to contact surfaces on said substrate.

13. The tool of claim 6 wherein said IC displacement assembly is adapted to linearly displace said IC.

14. The tool of claim 13 wherein said IC displacement assembly is adapted to angularly displace said IC about at least one axis.

15. The tool of claim 13 wherein said IC displacement assembly is adapted to linearly displace said IC in increments of less than 1 micrometer.

16. A method of aligning leads on an integrated circuit (IC) device with predetermined interface surfaces on a substrate comprising:
positioning the substrate on a platen;
vacuum engaging the IC with the tip of a conduit;
displacing the engaged IC to a position opposite the substrate; and
precisely positioning contact surfaces on the IC with respect to predetermined interface surfaces on the substrate while observing the 1C with a microscope.

17. The method of claim 16 wherein said precisely positioning conductive interface surfaces of an IC comprises displacing the conduit engaging the IC.

18. The method of claim 16 wherein said precisely positioning conductive interface surfaces of an IC comprises relatively displacing the platen with respect to the microscope.

19. The method of claim 16 further comprising directing cool oxygen replacement gas from the conduit onto the IC.

20. The method of claim 16 further comprising heating the substrate to reflow solder thereon to attach contact surfaces of the IC to the predetermined interface surfaces of the substrate.

21. A method of making a solderability alignment tool for aligning conductive interface surfaces of an integrated circuit with predetermined interface surfaces of a substrate comprising:
providing an electronic manual probe station having a platen, a microscope, an electrical probe and a probe displacement assembly attached to the electrical probe; and
replacing the electrical probe assembly with an elongate conduit that is operably connected to the probe displacement assembly.
